(19) United States
(12) Patent Application Publication
(10) Pub. No.: US 2024/0410761 A1
(43) Pub. Date: Dec. 12, 2024

(54) TEMPERATURE MEASUREMENT METHOD AND TEMPERATURE MEASUREMENT DEVICE

(71) Applicants: SEMES CO., LTD., Cheonan-si (KR); Korea Advanced Institute of Science and Technology, Daejeon (KR)

(72) Inventors: Jin Hee HONG, Cheonan-si (KR); Young Eun JEON, Cheonan-si (KR); Sang Hyun SON, Cheonan-si (KR); Yong Jun SEO, Cheonan-si (KR); Jung Won KIM, Daejeon (KR); Jin Ho BAE, Changwon-si (KR)

(73) Assignees: SEMES CO., LTD., Cheonan-si (KR); Korea Advanced Institute of Science and Technology, Daejeon (KR)

(21) Appl. No.: 18/737,929

(22) Filed: Jun. 7, 2024

(30) Foreign Application Priority Data
Jun. 9, 2023 (KR) 10-2023-0074476

(51) Int. Cl. G01J 5/59

(52) U.S. Cl. CPC G01J 5/59

(57) ABSTRACT

Proposed is a temperature relation equation derivation method which includes irradiating a same point of a target substance with heating light for heating the target substance and measurement light for detecting a change of a reflectivity of the target substance caused by the heating light, detecting light of detecting intensity of each of incident light and reflected light of the measurement light, and calculating of deriving a temperature relation equation based on the reflectivity of the target substance by using a value detected in the detecting of light.

### CROSS REFERENCE TO RELATED APPLICATION

The present application claims priority to Korean Patent Application No. 10-2023-0074476, filed Jun. 9, 2023, the entire contents of which are incorporated herein for all purposes by this reference.

### BACKGROUND OF THE INVENTION

### Field of the Invention

The present disclosure relates to a temperature measurement method and a temperature measurement device for measuring the surface temperature of a substance.

### Description of the Related Art

For equipment that manufacture and inspect semiconductor chips under various environmental conditions, it is important to form a uniform process temperature distribution over a wide range. In order to control such a uniform temperature distribution to be formed, accurate temperature measurement is required.

For example, in a substrate heat treatment process, a substrate may be brought into a high-speed heat treatment device and exposed to a pulsed light beam during the process. In this case, the surface of an area exposed to the pulsed light beam may be heated at temperatures as high as 1000° C. or more for short periods of time lasting less than 1 ms to less than 1 μs.

Due to high temperatures, structural changes may occur in the area exposed to the pulsed light beam. Since the extent of structural changes depends on temperatures, it is important to accurately monitor temperatures while the heat treatment process is performed.

### SUMMARY OF THE INVENTION

Accordingly, the present disclosure has been made keeping in mind the above problems occurring in the related art, and the present disclosure is intended to propose a temperature measurement method and a temperature measurement device, in which the change of the rapidly changing surface temperature of a target substance can be measured with high accuracy.

In addition, the present disclosure is intended to propose a temperature relation equation which can be applied to the temperature measurement method and temperature measurement device in which the change of the rapidly changing surface temperature of a target substance can be measured with high accuracy.

The objectives that the present disclosure seeks to obtain are not limited to the above-mentioned objectives, and objectives not mentioned can be clearly understood by those skilled in the art in the technical field to which the present disclosure belongs from this specification and the attached drawings.

In order to achieve the objectives of the present disclosure, according to an embodiment of the present disclosure, there is provided a temperature measurement device including: a measurement light source configured to irradiate one point of a surface of a target substance with measurement light for measuring a surface temperature of the target substance; an optical system configured to form an optical path of the measurement light toward the surface of the target substance; a plurality of detection members configured to detect an intensity of each of incident light and reflected light of the measurement light; and a processor configured to calculate reflectivity of the target substance based on a detection value of each of the plurality of detection members and to determine the surface temperature of the target substance based on the reflectivity.

In the embodiment, the optical system may include a polarization separator configured to separate the reflected light into p-polarized reflected light and s-polarized reflected light.

In the embodiment, the plurality of detection members may include: a first detection member configured to output the intensity of the incident light; a second detection member configured to output an intensity of the p-polarized reflected light; and a third detection member configured to output an intensity of the s-polarized reflected light.

In the embodiment, the processor may calculate a polarization reflectivity of the target substance based on the detection value of each of the plurality of detection members.

In the embodiment, the processor may determine the surface temperature of the target substance by applying the polarization reflectivity of the target substance to a pre-stored temperature relation equation defining relationship between a surface temperature of the target substance and a reflectivity of the target substance.

In the embodiment, the temperature relation equation may be a linear relation equation derived from a polarization reflectivity of the target substance at a room temperature and a polarization reflectivity of the target substance at a melting point thereof.

In the embodiment, the temperature relation equation may be derived by changing the surface temperature of the target substance up to melting point by irradiating the surface of the target substance with heating light and the measurement light.

In the embodiment, the temperature measurement device may further include a display configured to display a change of the surface temperature of the target substance over time.

According to an embodiment of the present disclosure, there is provided a temperature measurement method including: irradiating a same point of a target substance with a heating light which is a pulsed beam for heating the target substance and a measurement light for detecting a change of a reflectivity of the target substance caused by the heating light; detecting an intensity of each of an incident light of the measurement light and a reflected light of the measurement light; deriving a temperature relation equation defining relationship between a surface temperature of the target substance and a reflectivity of the target substance by using a value of the detected intensity of each of the incident light of the measurement light and the reflected light of the measurement light; and determining the surface temperature of the target substance by using the temperature relation equation.

In the embodiment, the intensity of the reflected light may be detected by separating the reflected light into p-polarized light and s-polarized light.

In the embodiment, the temperature relation equation is derived from a value detected from at least one of the p-polarized light and s-polarized light of the reflected light according to a type of a substance of a surface of the target substance.

In the embodiment, the deriving the temperature relation equation may include: calculating a polarization reflectivity of the target substance; and deriving a linear temperature relation equation of the target substance based on the polarization reflectivity.

In the embodiment, wherein the linear temperature relation equation may be derived from a polarization reflectivity at a time at which the target substance is at a room temperature and a polarization reflectivity at a time at which the surface temperature of the target substance reaches a melting point of the target substance.

In the embodiment, the polarization reflectivity is determined from a graph showing a p-polarization reflectivity of the target substance according to a change of time, three inflection points may be included in a maximum value region or a minimum value region according to at least one of the type of the target substance and an incident angle of the measurement light.

In the embodiment, when the three inflection points are included in the maximum value region of the graph, the polarization reflectivity at the time at which the surface temperature of the target substance reaches the melting point may be a maximum value of the graph.

In the embodiment, when the three inflection points are included in the minimum value region of the graph, the polarization reflectivity at the time at which the surface temperature of the target substance reaches the melting point may be a minimum value of the graph.

According to the embodiment of the present disclosure, there is provided a temperature measurement method including: calculating and storing the temperature relation equation defining relationship between a surface temperature of a target substance and a reflectivity of the target substance based on a reflectivity of a target substance; irradiating a measurement light for measuring a surface temperature of the target substance to be incident obliquely on one point of the target substance; detecting an intensity of each of an incident light of the measurement light and a reflected light of the measurement light which is incident obliquely on the target substance; and calculating the surface temperature of the target substance by applying a value of the detected intensity of each of the incident light of the measurement light and the reflected light of the measurement light to the temperature relation equation, wherein in the detecting of light, the intensity of the reflected light is detected by separating the reflected light into p-polarized light and s-polarized light.

In the embodiment, the temperature relation equation may be the linear relation equation derived from a polarization reflectivity of the target substance at a room temperature and a polarization reflectivity of the target substance at a melting point thereof.

In the embodiment, the surface temperature of the target substance is calculated by using a value detected from at least one of the p-polarized light and s-polarized light of the reflected light according to a type of a substance of a surface of the target substance, and the calculating the surface temperature of the target substance may include: calculating a polarization reflectivity of the target substance; and calculating the surface temperature of the target substance by applying the polarization reflectivity calculated in the first calculating to the temperature relation equation.

In the embodiment, the temperature measurement method may further include displaying a change of the surface temperature of the target substance over time.

According to the embodiment of the present disclosure, the temperature relation equation can be obtained based on the reflectivity of the target substance at each of a room temperature and a melting point thereof. By applying the temperature relation equation to a temperature measurement technology, the change of the rapidly changing surface temperature of the target substance can be accurately and rapidly calculated.

In addition, reflected light is separated into p-polarized light and s-polarized light to detect intensity thereof, so the detected value can be selectively applied to temperature measurement depending on the type of a substance to be measured.

The effects of the present disclosure are not limited to the effects described above, and effects not mentioned may be clearly understood by those skilled in the art in the technical field to which the present disclosure belongs from this specification and the attached drawings.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram simply illustrating a temperature measurement device according to an embodiment of the present disclosure;

FIG. 2 is a flowchart simply illustrating a temperature measurement method according to the embodiment of the present disclosure;

FIGS. 3 to 6 illustrate schematically examples of graphs derived by using the device of FIG. 1 and the method of FIG. 2; and

FIG. 7 is a flowchart simply illustrating a temperature measurement method according to the embodiment of the present disclosure.

### DETAILED DESCRIPTION OF THE INVENTION

Hereinafter, with reference to the attached drawings, embodiments of the present disclosure will be described in detail so that those skilled in the art can easily perform them. The present disclosure may be implemented in various different forms and is not limited to the embodiments described herein.

In order to clearly describe the present disclosure, parts not related to the description are omitted, and identical or similar elements are given the same reference numerals throughout the specification.

In addition, in various embodiments, components having the same configuration will be described only in representative embodiments by using the same reference numerals, and in other embodiments, only components that are different from the representative embodiment will be described.

Throughout the specification, when a part is said to be “connected (or combined)” with another part, this includes not only a case in which the part is “directly connected (or combined)” therewith but also a case in which the part is “indirectly connected (or combined)” therewith with still another part placed therebetween. In addition, when a part is said to “include” a certain component, this means that it may further include other components rather than excluding the other components, unless specifically stated to the contrary.

Unless otherwise defined, all terms used herein, including technical or scientific terms, have the same meaning as commonly understood by those skilled in the art to which the present disclosure pertains. Terms defined in commonly used dictionaries should be interpreted as having meanings consistent with meanings in the context of the related technology, and should not be interpreted in ideal or excessively formal meanings unless explicitly defined in the present application.

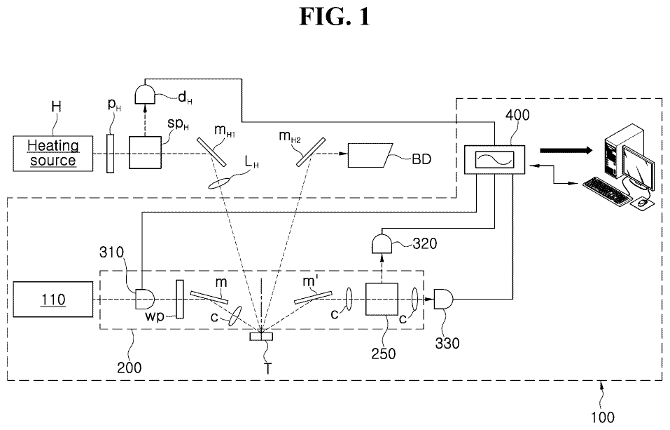

FIG. 1 is a configuration diagram simply illustrating a temperature measurement device according to an embodiment of the present disclosure.

The temperature measurement device 100 according to the present disclosure may be applied to a semiconductor manufacturing process. More specifically, the temperature measurement device 100 according to the present disclosure may be a device for measuring the surface temperature of a substrate that is heat treated by a rapid thermal source. Accordingly, a target substance T whose surface temperature is intended to be measured may be a substrate. The substrate is, for example, a wafer. The substrate may typically be, for example, a silicon wafer or composite wafer commonly used in a semiconductor device industry. The substrate may be heat treated while placed inside a process chamber configured for heat treatment.

The temperature measurement device 100 according to the embodiment of the present disclosure uses the technology of measuring the surface temperature of a target substance by using polarization reflectivity recovered from the surface of the target substance whose surface temperature is intended to be measured.

The vibrational movement of particles (atoms) that make up a solid crystal increases the available volume of the particles due to increase in vibrational energy as a temperature increases, resulting in thermal expansion. In addition, when a temperature increases in the same unit volume, the polarizability of the particles also increases (related to complex permittivity). Accordingly, thermal expansion and polarizability change according to a temperature are determined to affect refractive index and reflectivity when injecting a light source, and relationship thereof is used.

Referring to FIG. 1, the temperature measurement device 100 according to the present disclosure may include a measurement light source 110, an optical system 200, a plurality of detection members, and a processor 400.

In order to measure the temperature change of the target substance T due to a heating light source H, the measurement light source 110 may irradiate the same reaching point of heating light from the heating light source H with measurement light. For example, the heating light source H may be a high-speed heat generation source that generates a pulse wave, and the measurement light source 110 may be a continuous wave (CW) laser that generates a continuous wave.

The heating light emitted from the heating source H is irradiated onto the target material T through a polarizer p_{H}, beam splitter sp_{H}, mirror m_{H1}, and lens l_{H}. A portion of the heating light separated at the beam splitter sp_{H} is incident on the light detector d_{H}. The light detector d_{H} transmits a signal of the detected heating light to the processor 400. The processor 400 may measure the intensity of the heating light based on the signal transmitted from the light detector d_{H}. The heating light reflected from the target material T is transmitted to the beam dump device BD through the mirror m_{H2}. The beam dump device BD absorbs and extinguishes the heating light.

Meanwhile, in order to improve the temperature consistency of measurement results, it is preferable that the measurement light source 110 applied to the temperature measurement device 100 has a wavelength region with high reflectivity for a material to be measured, that is, the target substance T. In addition, the measurement light source 110 preferably has high optical power in consideration of optical power loss due to components that process reflected light. In addition, as for the measurement light source, it is preferable that relative intensity noise (RIN) % is low or noise filtering is easy, and when calibrating an output voltage value (corresponding to the intensity of reflected light) at room temperature (a reference temperature) and melting point corresponding to a temperature measurement range, the more temperature calibration points the better.

The optical system 200 is a component for forming an optical path of measurement light and directs the measurement light received from the measurement light source 110 toward the surface of the target substance T. For example, the optical system 200 may include a wave plate wp configured to generate an optical path difference of the measurement light, and at least one light collection member c configured to focus the measurement light on the surface of the target substance T.

In addition, the optical system 200 may further include a plurality of mirror members m to provide an appropriate direction to the measurement light. The measurement light may be incident on the surface of the target substance T by a mirror member m disposed at an appropriate angle at an appropriate position, and reflected light reflected from the surface of the target substance T may reach a detection member to be described later by another mirror member m′ disposed at an appropriate angle at an appropriate position.

The optical system 200 may further include a polarization separator 250 that separates light reflected from the surface of the target substance T into two polarized lights, specifically, s-polarized reflected light and p-polarized reflected light. The polarization separator 250 may improve the temperature accuracy of measurement results by separating p-polarized light with a large reflectivity change through polarization separation of reflected light. The polarization separator 250 is arranged in a section between the target substance T and a detection member for detecting reflected light. In other words, the reflected light is separated by the polarization separator 250 and then reaches the detection member disposed to detect the reflected light. For example, the polarization separator may be a polarization beam splitter. Alternatively, the polarization separator may be a Wollaston prism.

Meanwhile, although not shown in detail, the polarization separator may be applied even to a section between the measurement light source 110 and the target substance T. The polarization separator applied to the section between the measurement light source 110 and the target substance T separates a portion of the measurement light incident on the target substance T, and the separated portion of the measurement light may be detected and analyzed as reference light. The reference light may later be used as a reference to correct the intensity of reflected light and minimize common noise.

The optical system 200 is preferably arranged so that the measurement light is incident obliquely on the surface of the target substance T. An angle at which the measurement light is incident may be any angle except Brewster's angle (an angle at which reflectivity is 0%). In order to improve the temperature consistency of temperature measurement values, the optical system is preferably configured so that the incident angle of the measurement light can have a peripheral (adjacent) incident angle of Brewster's angle (an angle at which reflectivity is 0%) at which the range of the p-polarization reflectivity change has a maximum value.

The detection member may include a plurality of detection members and may generate an electrical signal representing the intensity of each of incident light and measurement light. More specifically, the detection member may detect the intensity of measurement light incident on the target substance T and reflected light reflected from the target substance T. For example, the detection member may be a photodiode (PD) that detects the intensity of reflected polarized light as a voltage signal. According to the embodiment of the present disclosure, the detection member may include a first detection member 310 that detects the intensity of incident light, a second detection member 320 that detects the intensity of the s-polarized reflected light of reflected light separated by the polarization separator, and a third detection member 330 that detects the intensity of p-polarized reflected light. The output values of the first detection member 310, the second detection member 320, and the third detection member 330 may be transmitted to the processor 400.

The processor 400 may determine the surface temperature of the target substance based on the detection value of each of the plurality of detection members. Specifically, the processor 400 may calculate the polarization reflectivity of the target substance based on the detection value of each of the plurality of detection members, and may determine the surface temperature of the target substance T from the calculated polarization reflectivity. In addition, the processor 400 may selectively use one of p-polarized light and s-polarized light of reflected light depending on the type of the substance of the surface of the target substance T. Since the reflectivity is a value obtained by dividing the intensity of the reflected light by the intensity of the incident light, the detection value of the second detection member 320 or the third detection member 330 is divided by the value of the first detection member 310 to obtain the p-polarization reflectivity or s-polarization reflectivity of the target substance T. Polarized reflectance can be calculated.

In order to determine the surface temperature of the target substance T from polarization reflectivity, the processor 400 may apply the obtained polarization reflectivity of the target substance T to a temperature relation equation defining relationship between a surface temperature of the target substance T and a reflectivity of the target substance T. In this case, the temperature relation equation may be derived by the temperature measurement device 100 and stored in the processor 400 before the temperature measurement device 100 is used for surface temperature measurement.

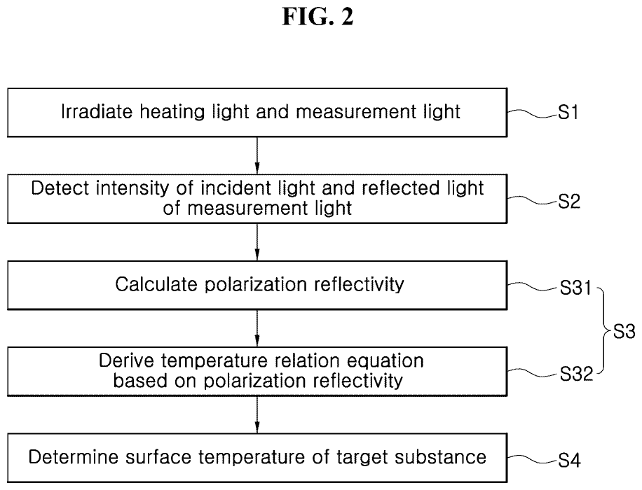

The temperature relation equation used to measure the surface temperature of the target substance T may be derived from the polarization reflectivity of the target substance T at room temperature and the polarization reflectivity of the target substance T at the melting point of the target substance T. In other words, the temperature relation equation is derived by changing the surface temperature of the target substance T up to melting point of the target substance T by irradiating the surface of the target substance T with heating light and the measurement light. The method of measuring temperature by deriving the temperature relation equation according to the embodiment of the present disclosure is illustrated in FIG. 2.

The temperature measurement method according to the embodiment of the present disclosure may include irradiating with light S1, detecting light S2, deriving the temperature relation equation S3, and determining the surface temperature S4.

The irradiating with light S1 is a step of irradiating one point of the target substance T with the heating light which is a pulsed beam for heating the target substance T and the measurement light for detecting change in the reflectivity of the target substance T by the heating light. In this case, the heating light with which the target substance T is irradiated is a pulse beam that has power to rapidly change the surface temperature of the target substance T up to a melting point thereof.

The detecting of light S2 is a step of detecting the intensities of incident light and reflected light of the measurement light, and the intensity of reflected light may be detected by separating the light into p-polarized light and s-polarized light. The detecting of light S2 may be performed by the plurality of detection members 310, 320, and 330 included in the optical system 200.

The deriving the temperature relation equation S3 is a step of deriving the temperature relation equation defining relationship between a surface temperature of the target substance T and the reflectivity of the target substance T by using the detection value of each of the plurality of detection members. The surface temperature of the target substance T is calculated by using a value detected from at least one of the p-polarized light and s-polarized light of the reflected light according to a type of a substance of a surface of the target substance T. The surface temperature of the target substance T is calculated by applying a value of the detected intensity of each of the incident light of the measurement light and the reflected light of the measurement light to the temperature relation equation.

The deriving the temperature relation equation S3 may include a step S31 of calculating polarization reflectivity of the target substance T, and a step of S32 deriving the temperature relation equation of the target substance T based on the polarization reflectivity. In this case, depending on the type of a substance of the surface of the target substance T, the polarization reflectivity of one of p-polarized light and s-polarized light may be selectively calculated and used.

Since reflectivity is a value obtained by dividing the intensity of reflected light by the intensity of incident light, the step S31 is calculating the p-polarization reflectivity and s-polarization reflectivity of the target substance T by using a value detected in the detecting of light S2. The p-polarization reflectivity may be obtained by dividing the detection value of the second detection member 320, which detects the voltage signal (intensity) of the p-polarized reflected light, by the detection value of the first detection member 310, which detects the voltage signal (intensity) of the incident light, and the s-polarization reflectivity may be obtained by dividing the detection value of the third detection member 330, which detects the voltage signal (intensity) of the s-polarized reflected light, by the detection value of the first detection member 310, which detects the voltage signal (intensity) of the incident light.

The step S32 is deriving the temperature relation equation from the polarization reflectivity of the target substance T at room temperature and the polarization reflectivity of the target substance T at a melting point thereof. For example, the step S32 may derive the temperature relation equation from the p-polarization reflectivity of the target substance T at the room temperature is and the p-polarization reflectivity of the target substance T that has reached the melting point.

When the target substance T exists as a solid, the amount of reflectivity change is proportional to the amount of temperature change. Reflectivity can be calculated by the step S31, and the room temperature and the melting point temperature of the target substance T are known values. Accordingly, a linear temperature relation equation can be derived from the polarization reflectivity of the target substance T at the room temperature and the polarization reflectivity of the target substance T at the melting point.

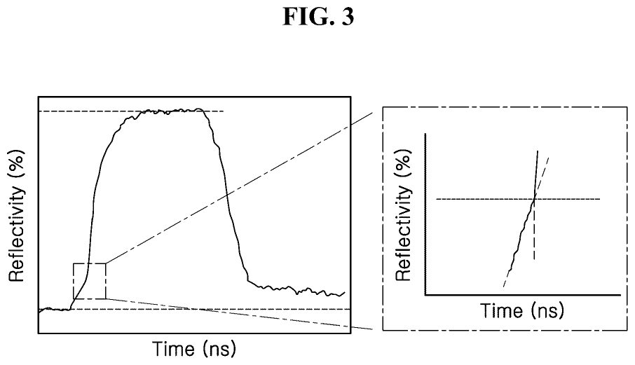

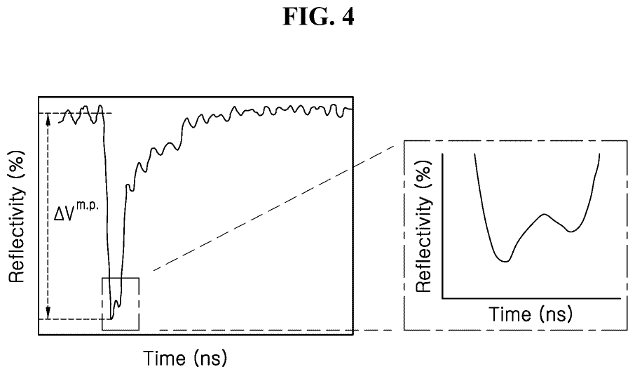

When the change of the polarization reflectivity of the target substance T over time by values calculated in the step S31 may be illustrated as in FIG. 3 or 4. FIG. 3 illustrates the change of the p-polarization reflectivity over time observed when irradiating the target substance with the measurement light at an incident angle equal to or less than Brewster's angle (an angle when reflectivity is 0, 75.5° in the case of silicon) when the target substance is a silicon (Si) substrate. FIG. 4 illustrates the change of the p-polarization reflectivity over time observed when irradiating the target substance with the measurement light at an incident angle greater than or equal to Brewster's angle when the target substance is a silicon (Si) substrate. In this way, the inversion pattern of the time-reflectivity graph based on Brewster's angle may be different depending on the type of the target substance T.

For example, in the case of a target substance T, when the incident angle of measurement light is greater than or equal to Brewster's angle, a graph like that of FIG. 3 may appear, and when the incident angle of measurement light is equal to or less than Brewster's angle, a graph like that of FIG. 4 may appear. That is, a graph of the change of polarization reflectivity over time according to the type of the target substance and the incident angle of the measurement light may appear like the graph of FIG. 3 or 4.

For a target substance according to the embodiment of the present disclosure, when a time-reflectivity graph output by irradiating the surface of the target substance with a pulsed beam, as heating light, which rapidly changes the temperature of the surface of the target substance up to the melting point of the target substance and introducing inspection light at an incident angle is like the graph of FIG. 3, polarization reflectivity at the melting point of a target substance T may be a maximum value among values calculated in the step S31. Specifically, the maximum value of a time-reflectivity graph output for one pulse of heating light may be the polarization reflectivity of the target substance T at the melting point of the target substance T.

On the other hand, for a target substance according to the embodiment of the present disclosure, when a time-reflectivity graph output by irradiating the surface of the target substance with a pulsed beam, as heating light, which rapidly changes the temperature of the surface of the target substance up to the melting point of the target substance, and introducing inspection light at an incident angle is like the graph of FIG. 4, polarization reflectivity of the target substance T at the melting point of a target substance T may be the minimum value among the values calculated in the first calculating S31. Specifically, the maximum value of a time-reflectivity graph output for one pulse of heating light may be the polarization reflectivity of the target substance T at the melting point of the target substance T.

The polarization reflectivity of a target substance at room temperature may be calculated by irradiating the target substance T only with measurement light without heating light. Alternatively, the polarization reflectivity of a target substance at room temperature may be derived from the starting area of a linear graph appearing in a time-reflectivity graph output according to the embodiment of the present disclosure. For example, as illustrated in FIGS. 3 and 4, when the starting point of a linear graph cannot be specified, the polarization reflectivity of a target substance at room temperature may be estimated by a median of values present in the starting area of the graph.

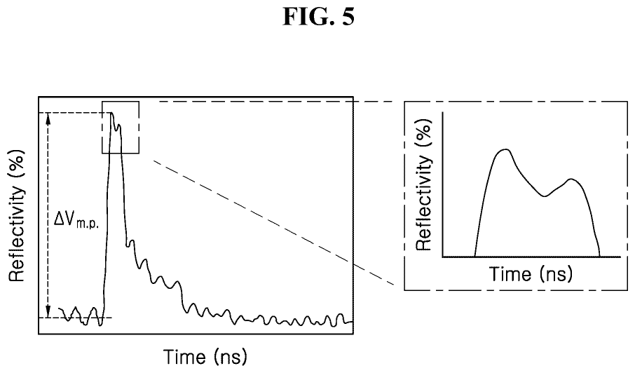

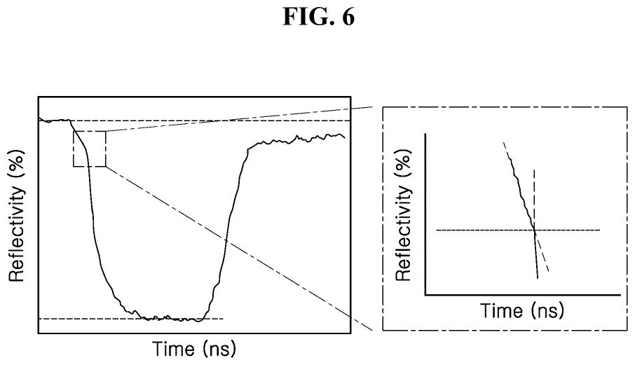

Meanwhile, when the temperature consistency of the temperature measurement device 100 is high, three inflection points may be included in the maximum or minimum value region of a time-reflectivity graph (see FIGS. 5 and 6). The higher the temperature consistency of the temperature measurement device 100, the more clearly the three inflection points may be observed. The polarization reflectivity can be identified from the graph at the melting point of the target substance T from the three inflection points included in the maximum or minimum value region. Specifically, among the three inflection points, a first inflection point that appears first in the flow of time may be time at which the surface temperature of the target substance T reaches the melting point. The closer the incident angle of the measurement light is to Brewster's angle, the better the temperature consistency of the temperature measurement device 100 can be. Accordingly, when irradiating the target substance with the measurement light at an optimal incident angle (an angle adjacent to the Brewster angle) that can maximize the temperature consistency of the temperature measurement device 100, a time-reflectivity graph output by the temperature measurement method according to the embodiment of the present disclosure may include three inflection points in the maximum value region or minimum value region. A reflectivity-temperature relation equation derived by the above-described method and values is as shown in Equation 1.

$$T = {T}_{RT} + Δ T = {T}_{RT} + \frac{Δ {T}_{m . p .}}{Δ {V}_{m . p .}} Δ V \qquad [ Equation 1 ]$$

In this case, T_{RT} is an absolute temperature at room temperature, ΔT_{m.p.} is the amount of change in temperature up to a melting point at the room temperature, and ΔV_{m.p.} is the amount of change in reflectivity up to the melting point at the room temperature. The surface temperature of the target substance T can be derived by putting the polarization reflectivity of the target substance T calculated from the detection value of the detection member into ΔV.

The processor 400 may determine the surface temperature of the target substance T by applying the polarization reflectivity of the target substance T to the linear temperature relation equation obtained from the polarization reflectivity of the target substance T at the room temperature and the polarization reflectivity of the target substance T at the melting point.

Meanwhile, the temperature measurement device 100 may include a display that displays the determined surface temperature of the target substance T as a graph over time. The display may display a change of the surface temperature of the target substance T over time. For example, the temperature measurement device 100 include a high-speed signal processing device, such as an oscilloscope.

In the embodiment, the processor 400 is or includes any processor or device that executes a series of software instructions and includes, without limitation, a general-purpose or dedicated microprocessor, a finite state machine, controller, computer, central processor (CPU), field-programmable gate array (FPGA), or digital signal processor. In the embodiment, the processor is an Intel XEON or PENTIUM processor, or an AMD TURION, or another device in the same processor field manufactured by AMD, Intel, or another semiconductor processor manufacturer.

The processor 400 is manipulatively connected to memory (not shown). In this specification, a term “memory” refers to any processor-readable medium including RAM, ROM, EPROM, PROM, EEPROM, a disk, a floppy disk, a hard disk, a CD-ROM, and a DVD, etc. in which a series of instructions executable by the processor 400 are stored, but is not limited to those mentioned above.

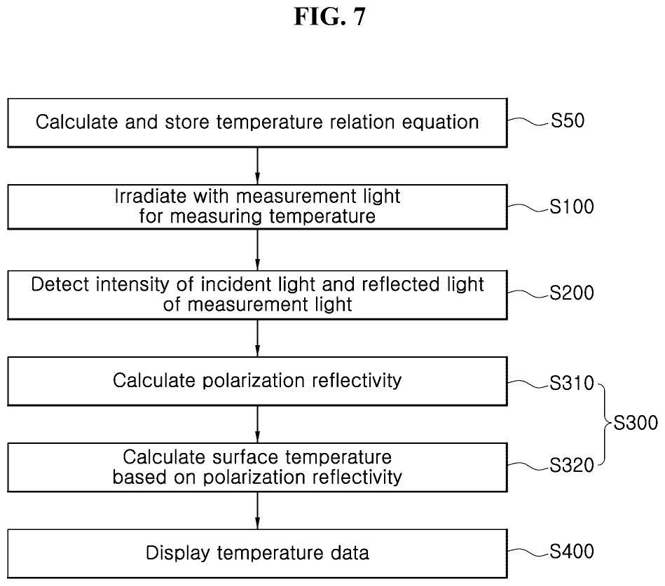

FIG. 7 is a flowchart simply illustrating the temperature measurement method according to the embodiment of the present disclosure. Referring to FIG. 7, the temperature measurement method according to the embodiment of the present disclosure may include the calculating and storing of a temperature relation equation S50, irradiating with light S100, detecting light S200, and calculating S300. By applying the temperature measurement method of FIG. 7 to the temperature measurement device illustrated in FIG. 1, the surface temperature of the target substance T may be measured.

The calculating and storing of a temperature relation equation S50 is a step performed before performing the surface temperature measurement of the target substance, and in the calculating and storing, a temperature relation equation is calculated based on the reflectivity of a substance to be measured, and a calculated relation equation is stored in the processor 400. The calculating and storing of a temperature relation equation S50 may be performed by the temperature measurement device 100 illustrated in FIG. 1, and since the calculating and storing is performed in the same manner as or a manner almost similar to the temperature relation equation derivation method described previously, description thereof will be omitted.

The irradiating with light S100 is a step of irradiating one point of the target substance T with the measurement light, and the measurement light is light used to measure the temperature change of the target substance. In this case, the measurement light may be incident obliquely on the surface of the target substance T.

For example, the measurement light may be a continuous beam emitted from a CW laser. The measurement light may be obliquely incident on the surface of the target substance T by the optical system 200, which forms an optical path toward the target substance T. In this case, as the measurement light is incident at an angle as close to Brewster's angle as possible, a measurement value with high accuracy can be derived.

The detecting of light S200 is a step of detecting the intensity of measurement light, and may include the process of detecting the intensity of incident light incident on the target substance T and the intensity of reflected light reflected from the target substance T. The detecting of light S200 may be performed by a detection member, such as a photo diode. The intensity of the incident light may be a value already specified as a set value. According to the embodiment of the present disclosure, the intensity of the reflected light is detected by separating the reflected light into the p-polarized reflected light and the s-polarized reflected light.

The calculating S300 is a step of calculating the surface temperature of the target substance T by using a value detected in the detecting of light S200. In the calculating S300, according to the material of the target substance T, the detection value of one of the p-polarized reflected light and the s-polarized reflected light may be applied.

The calculating S300 may include a step S310 of calculating the polarization reflectivity of the target substance T and a step S320 of calculating the surface temperature of the target substance T based on the polarization reflectivity.

The step S310 may be simply performed by using the detection value of the detecting of light S200. Reflectivity is a value obtained by dividing the intensity of the reflected light by the intensity of the incident light. Accordingly, the step S310 may be a step of dividing the detection value of one of the p-polarized reflected light and the s-polarized reflected light by the detection value of the incident light. The step S310 may be performed by the processor 400.

The step S320 is the step of calculating the surface temperature of the target substance T by using the polarization reflectivity calculated in the first calculating S310, and may apply the temperature relation equation represented in equation 1 derived in step S50 and stored in the processor 400.

Accordingly, the second calculating S320 may include a step of putting the polarization reflectivity calculated in the step S310 into the linear temperature relation equation derived by using the reflectivity of the target substance T at the room temperature, the reflectivity of the target substance T at the melting point, the temperature value of the room temperature, the temperature value of the target substance at the melting point. The first calculating S310 and the second calculating S320 may be performed by the processor 400. For example, the processor 400 is or includes any processor or device that executes a series of software instructions, and may be performed by, without limitation, a general-purpose or dedicated microprocessor, a finite-state machine, a controller, a computer, a central processor (CPU), a field-programmable gate array (FPGA), or a digital signal processor.

Meanwhile, the temperature measurement method according to the present disclosure may further include displaying data S400 on the surface temperature of the target substance T.

As described above, according to the present disclosure, the surface temperature of the target substance is calculated based on polarization reflectivity recovered from the surface of the target substance and is applied to a high-speed signal processing device so that the surface temperature of the target substance subjected to high-speed heat treatment can be monitored in real time. In particular, it can be checked that the accuracy of measurement results is improved by using polarization reflectivity.

Although the present disclosure has been described above, the present disclosure is not limited to the disclosed embodiments and the attached drawings, and may be modified in various ways by those skilled in the art without departing from the technical spirit of the present disclosure. In addition, each of the embodiments according to the technical spirit of the present disclosure may be implemented independently, or two or more thereof may be implemented in combination.

What is claimed is:

1. A temperature measurement device comprising:
a measurement light source configured to irradiate one point of a surface of a target substance with measurement light for measuring a surface temperature of the target substance;
an optical system configured to form an optical path of the measurement light toward the surface of the target substance;
a plurality of detection members configured to detect an intensity of each of incident light and reflected light of the measurement light; and
a processor configured to:
calculate reflectivity of the target substance based on a detection value of each of the plurality of detection members; and
determine the surface temperature of the target substance based on the reflectivity.

2. The temperature measurement device of claim 1, wherein the optical system comprises a polarization separator configured to separate the reflected light into p-polarized reflected light and s-polarized reflected light.

3. The temperature measurement device of claim 2, wherein the plurality of detection members comprises:
a first detection member configured to output the intensity of the incident light;
a second detection member configured to output an intensity of the p-polarized reflected light; and
a third detection member configured to output an intensity of the s-polarized reflected light.

4. The temperature measurement device of claim 3, wherein the processor is configured to calculate a polarization reflectivity of the target substance based on the detection value of each of the plurality of detection members.

5. The temperature measurement device of claim 4, wherein the processor is configured to determine the surface temperature of the target substance by applying the polarization reflectivity of the target substance to a temperature relation equation defining a relationship between a surface temperature of the target substance and a reflectivity of the target substance.

6. The temperature measurement device of claim 5, wherein the temperature relation equation is a linear relation equation derived from a polarization reflectivity of the target substance at a room temperature and a polarization reflectivity of the target substance at a melting point thereof.

7. The temperature measurement device of claim 6, wherein the temperature relation equation is derived by changing the surface temperature of the target substance up to melting point of the target substance by irradiating the surface of the target substance with heating light and the measurement light.

8. The temperature measurement device of claim 1, further comprising:
a display configured to display a change of the surface temperature of the target substance over time.

9. A temperature measurement method comprising:
irradiating a same point of a target substance with a heating light which is a pulsed beam for heating the target substance and a measurement light for detecting a change of a reflectivity of the target substance caused by the heating light;
detecting an intensity of each of an incident light of the measurement light and a reflected light of the measurement light;
deriving a temperature relation equation defining relationship between a surface temperature of the target substance and the reflectivity of the target substance by using a value of the detected intensity of each of the incident light of the measurement light and the reflected light of the measurement light; and
determining the surface temperature of the target substance by using the temperature relation equation.

10. The method of claim 9, wherein the intensity of the reflected light is detected by separating the reflected light into p-polarized light and s-polarized light.

11. The temperature measurement method of claim 10, wherein the temperature relation equation is derived from a value detected from at least one of the p-polarized light and s-polarized light of the reflected light according to a type of a substance of a surface of the target substance.

12. The temperature measurement method of claim 11, wherein deriving the temperature relation equation comprises:
calculating a polarization reflectivity of the target substance; and
deriving a linear temperature relation equation of the target substance based on the polarization reflectivity.

13. The temperature measurement method of claim 12, wherein in the linear temperature relation equation is derived from a polarization reflectivity at a time at which the target substance is at a room temperature and a polarization reflectivity at a time at which the surface temperature of the target substance reaches a melting point of the target substance.

14. The temperature measurement method of claim 13, wherein the polarization reflectivity is identified from a graph showing a p-polarization reflectivity of the target substance according to a change of time, three inflection points are included in a maximum value region or a minimum value region according to at least one of the type of the target substance and an incident angle of the measurement light.

15. The temperature measurement method of claim 14, wherein when the three inflection points are comprised in the maximum value region of the graph,
the polarization reflectivity at the time at which the surface temperature of the target substance reaches the melting point is a maximum value of the graph.

16. The temperature measurement method of claim 14, wherein when the three inflection points are comprised in the minimum value region of the graph,
the polarization reflectivity at the time at which the surface temperature of the target substance reaches the melting point is a minimum value of the graph.

17. A temperature measurement method comprising:
calculating and storing a temperature relation equation defining relationship between a surface temperature of a target substance and a reflectivity of the target substance;
irradiating a measurement light for measuring a surface temperature of the target substance to be incident obliquely on one point of the target substance;
detecting an intensity of each of an incident light of the measurement light and a reflected light of the measurement light which is incident obliquely on the target substance; and
calculating the surface temperature of the target substance by applying a value of the detected intensity of each of the incident light of the measurement light and the reflected light of the measurement light to the temperature relation equation,
wherein in the detecting of light, the intensity of the reflected light is detected by separating the reflected light into p-polarized light and s-polarized light.

18. The temperature measurement method of claim 17, wherein the temperature relation equation is a linear relation equation derived from a polarization reflectivity of the target substance at a room temperature and a polarization reflectivity of the target substance at a melting point thereof.

19. The temperature measurement method of claim 18, wherein the surface temperature of the target substance is calculated by using a value detected from at least one of the p-polarized light and s-polarized light of the reflected light according to a type of a substance of a surface of the target substance, and
wherein calculating the surface temperature of the target substance comprises:
calculating a polarization reflectivity of the target substance; and
calculating the surface temperature of the target substance by applying the polarization reflectivity to the temperature relation equation.

20. The temperature measurement method of claim 17, further comprising:
displaying a change of the surface temperature of the target substance over time.
